(19) United States
(12) Patent Application Publication
(10) Pub. No.: US 2007/0278927 A1
(43) Pub. Date: Dec. 6, 2007

(54) Luminescent compact fluorescent light bulb

(76) Inventor: Gary L. Butler, College Park, GA (US)

Correspondence Address: MERCHANT & GOULD PC, P.O. BOX 2903, MINNEAPOLIS, MN, 55402-0903, US

(21) Appl. No.: 11/444,709

(22) Filed: Jun. 1, 2006

(51) Int. Cl. H01J 5/48; H01J 5/50; H01J 63/04

(52) U.S. Cl. 313/318.01; 313/318.12; 313/485

(57) ABSTRACT

The invention provides a light bulb that glows in the dark after activation by incident electromagnetic radiation. The element that glows in the dark is an energy storage element and is placed in the center of the light bulb. Furthermore, a reflector is incorporated into the light bulb and/or energy storage element to effectively direct the electromagnet radiation emitted from the luminescent phosphor into an open space.

### CROSS REFERENCE TO RELATED APPLICATION

This application is related to the co-pending U.S. patent application entitled “LUMINESCENT LAMP SHADE,” filed concurrently with this application on Mar. 10, 2006 and accorded Ser. No. ______, which is herein incorporated in its entirety by reference.

### FIELD OF INVENTION

The present invention relates to a fluorescent light bulb. More particularly, to a luminescent compact fluorescent light bulb having a phosphorescence compound impregnated in a polymer substrate wherein after excitation by a light source, the luminescent compact fluorescent light bulb will “glow in the dark” for an extended period of time and a reflector to reflect the emitted light.

### BACKGROUND OF THE INVENTION

Luminescence describes a process in which a chemical compound or element absorbs energy from electromagnetic radiation; upon absorbing energy, electrons are excited to a higher energy state. When the electrons return to their ground state, electromagnetic radiation is emitted. A photoluminescent process is a subset of luminescence processes, and describes a luminescence process that occurs when the incident radiation and emitted radiation are in the visible spectrum.

Phosphorescence is the persistent emission of electromagnetic radiation following exposure to and removal from exposure to incident electromagnetic radiation. An object that exhibits phosphorescence is also said to “glow in the dark.” A phosphor is a substance that exhibits phosphorescence or luminescence.

Fluorescence is luminescence that is caused by the absorption of incident electromagnetic radiation followed by nearly immediate reradiation of electromagnetic radiation. The reradiation ceases almost immediately when the incident radiation ceases. Furthermore, in a fluorescence process, the incident electromagnetic radiation usually has a wavelength that differs from that of the emitted electromagnetic radiation.

Phosphorescent light bulbs come in both fluorescent and incandescent varieties and have time frames of 15 to 45 minutes of phosphorescence time upon removal from incident radiation. Fluorescent light bulbs that achieve phosphorescence have two components. The first component is a standard fluorescent tube, such as that found in an office building. The second component is an outer glass bulb that is coated with a phosphorescence phosphor. This phosphorescence phosphor is applied to either the interior or exterior of the outer glass bulb. The fluorescent tube generates light which energizes the phosphorescence phosphor during normal usage.

Phosphorescent light bulbs of the incandescent varieties are standard off-the-shelf light bulbs that contain a tungsten filament and a glass bulb. The tungsten filament generates light to charge the phosphorescence phosphor during normal usage. The glass bulb is coated with a phosphorescent phosphor which is applied to either the interior or the exterior of the glass bulb. The extreme heat generated by incandescent light bulbs adversely affects many phosphorescence phosphors.

The incandescent light bulb consists of a glass enclosure (the “bulb”) which either contains a vacuum or is filled with a low-pressure noble gas. Inside of this is a filament, often made of tungsten, through which an electrical current is passed. The heating of the filament causes it to emit light and the vacuum/inert gas inside the bulb prevents the filament from burning out due to evaporation. Incandescent light bulbs usually also contain a glass mount on the inside, which supports the filament and allows the electrical contacts to run through the bulb.

A compact fluorescent lamp (CFL) contains two main components: the gas-filled tube (also called bulb or burner) and the magnetic or electronic ballast. Electrical energy in the form of an electrical current from the ballast flows through the gas, causing the gas to give off ultraviolet light. The ultraviolet light then excites a white phosphor coating on the inside of the tube. This coating emits visible light. CFLs that “flicker” when they start have magnetic ballasts. CFLs with electronic ballasts are now much more common.

A fluorescent lamp is a type of lamp that uses electricity to excite mercury vapor in an atmosphere of argon or neon gas, resulting in a plasma that produces short-wave ultraviolet light. This light then causes a phosphor to fluoresce, producing visible light. The inner surface of the bulb is coated with a fluorescent paint made of varying blends of metallic and rare-earth phosphor salts.

In current phosphorescence light bulbs the phosphor coating covers the entirety of the glass bulb. The coating of the glass bulb creates inefficiency in that the generated light is impeded by the phosphor coating. In addition, protective coatings, such as aluminum oxide powders, are applied to the phosphor coated glass bulb to help combat flaking, cracking, and/or separation of the phosphor coating. This protective coating also creates inefficiency in that there is now a second layer of material which the generated light must traverse. The various coating may be applied to the exterior and/or interior surface of the glass bulb.

There exist a need for a phosphorescent light bulb that will provide long phosphorescence times, will not impede, interrupt, or block the light being generated by a light bulb, and will allow a user to reuse the phosphorescent material if the light bulb malfunctions.

### BRIEF SUMMARY OF THE INVENTION

An object of the present invention is to provide an improved light bulb. Another object of the present invention is to provide a light bulb comprising an energy storage element which comprises a phosphorescence phosphor with phosphorescence times of up to, and in excess of 8 hours. A further object of the present invention is to provide a light bulb or other lighting fixture comprising an energy storage element wherein the energy storage element does not impede, interrupt, or block the light being generated. An even further object of the present invention is to remove the need to provide a protective coating to a glass bulb section of a light bulb in order to protect the phosphorescence phosphor.

A further object of the present invention is to provide an energy storage element comprising a luminescent compound mixed with a transparent or semi-transparent material such as a polymer that is easily manufactured using techniques such as injection molding and extrusion. In addition, the energy storage element can be incorporated into any light fixture.

The inventive scope of the energy storage element is to capture energy from emitted light that would otherwise be inefficiently used to illuminate interior spaces or voids in a light bulb and not other inhibit the emission of light into a space during normal operation of the light bulb. The inventive scope of the reflector component is to reflect light emitted by both the light emitting element and energy storage element into a space for illumination purposes.

### BRIEF DESCRIPTION OF THE FIGS.

Non-limiting and non-exhaustive embodiments are described with reference to the following figures, wherein like reference numerals refer to like parts throughout the various views unless otherwise specified.

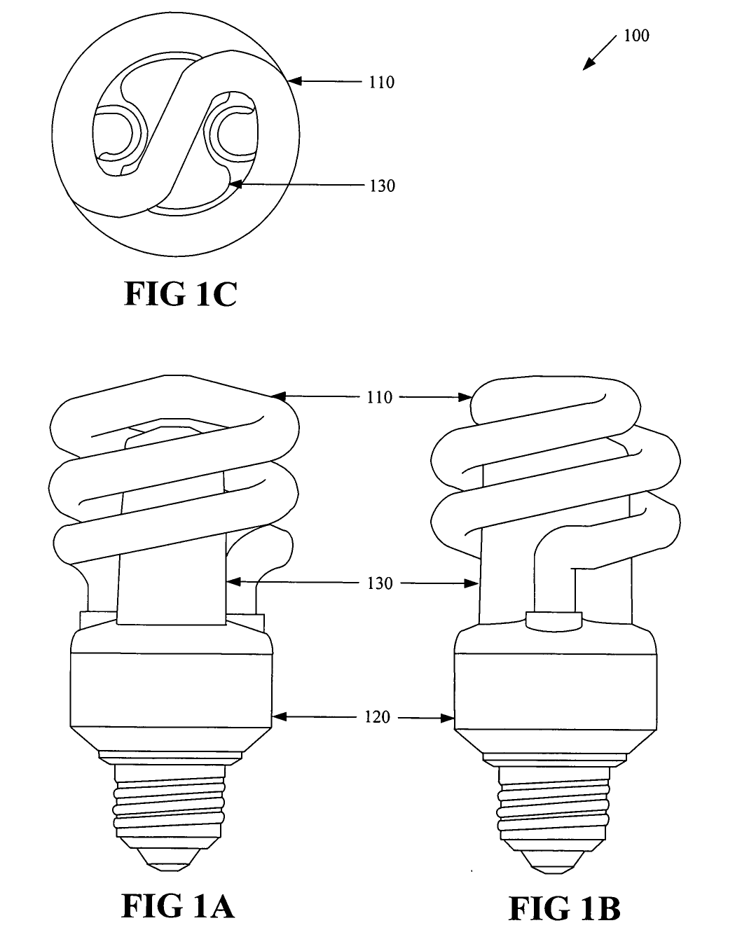

FIG. 1A depicts the front view of a multi-view of a compact fluorescent light bulb consistent with an exemplary embodiment of the present invention.

FIG 1B depicts the right view of a multi-view of a compact fluorescent light bulb consistent with an exemplary embodiment of the present invention.

FIG. 1C depicts the top view of a multi-view of a compact fluorescent light bulb consistent with an exemplary embodiment of the present invention.

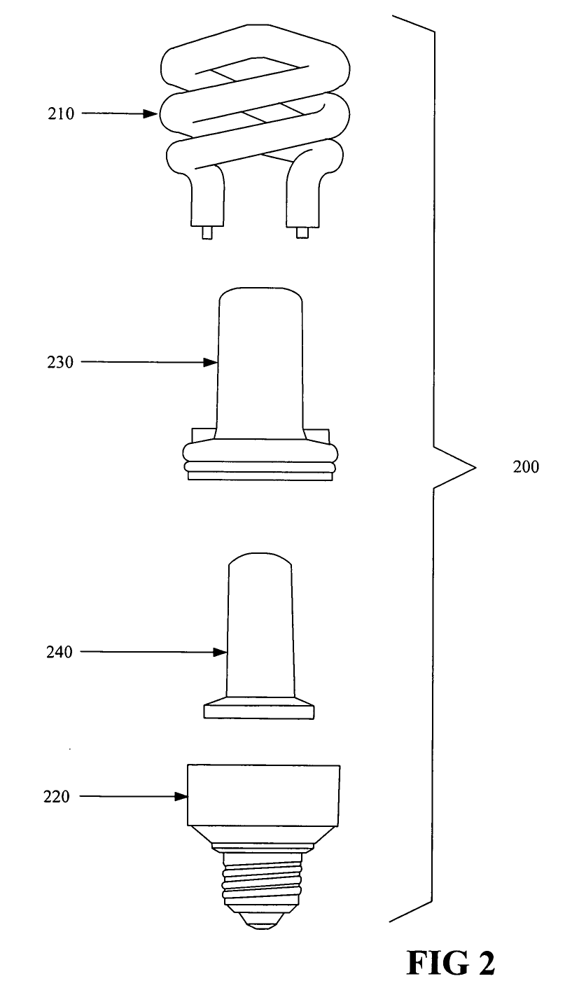

FIG. 2 depicts an exploded assembly of a compact fluorescent light bulb consistent with an exemplary embodiment of the present invention.

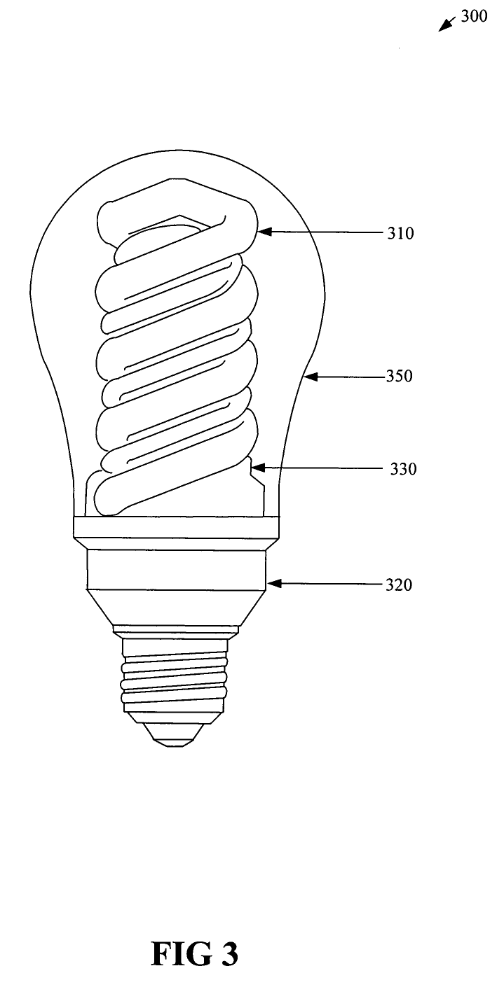

FIG. 3 depicts a compact fluorescent light bulb consistent with an alternate embodiment of the present invention.

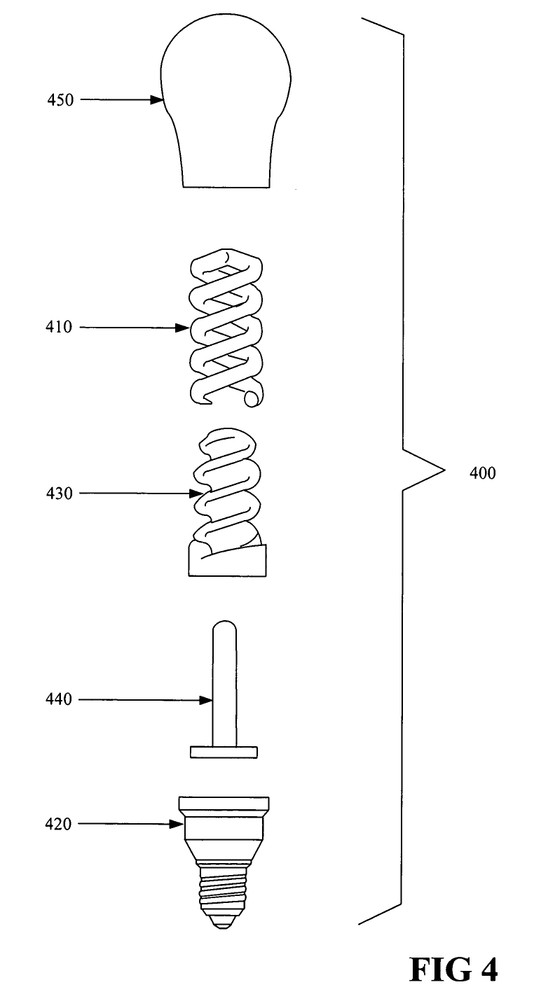

FIG. 4 depicts an exploded assembly of a compact fluorescent light bulb consistent with an alternate embodiment of the present invention.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as hardware, accessories, systems, devices, or methods. Accordingly, embodiments may take the form of a hardware implementation, an accessory, article of manufacture, or an implementation combining an accessory, article of manufacture and hardware aspects. The following detailed description is, therefore, not to be taken in a limiting sense.

The logical operations of the various embodiments are implemented (a) as a complete light bulb incorporating various aspects of the invention and/or (b) as an accessory incorporating various aspects of the invention capable of being added to existing light bulbs, hardware, accessories, light fixtures, or any combination of the aforementioned items. The implementation is a matter of choice dependent on the performance requirements and needs of the user implementing an embodiment. Accordingly, the logical operations making up the embodiments described herein are referred to alternatively as light bulbs, hardware, accessories, light fixtures, or combination of the aforementioned items.

The present invention is a light bulb that provides a light emitting element that is proximate an energy storage element. In various embodiments shown below the light emitting element encircles the energy storage element. It is contemplated that in other embodiments the light emitting element will not encircle the energy storage element. For example, the light emitting element may consist of a straight fluorescent tube(s), or of straight fluorescent tubes with an energy storage element parallel or perpendicular to the straight fluorescent tube(s).

During normal operation of the light bulb, light emitted by the light bulb is incident on the energy storage element. The energy storage element contains a luminous phosphor that absorbs energy from the incident light or other electromagnetic radiation. Upon removal of the incident light or electromagnetic radiation, the luminous phosphor contained in the energy storage element will emit light.

Furthermore, the energy storage element may be complemented with a reflector that will reflect light emitted by the energy storage element and/or the light emitting element out into a space. For example, if an energy storage element and reflector is placed in proximity to fluorescent tubes, light emitted by the fluorescent tubes and/or energy storage element that is directed toward the center of the lighting fixture will be reflected out into a space for illumination purposes.

Referring more particularly to the drawings, FIG. 1 depicts a multi-view illustration of a compact fluorescent light bulb 100 consistent with an exemplary embodiment of the present invention. The compact fluorescent light bulb 100 comprises a sealed glass tube 110, ballast 120, energy storage element 130, and reflector (not shown). As depicted in FIG. 1, the sealed glass tube 110 is helical in shape and encircles the energy storage element 130. By encircling the energy storage element 130, light emitted by the sealed glass tube 110 charges the energy storage element 130 during operation of the light bulb 100. An advantage of having the sealed glass tube 110 encircle the energy storage element 130 as opposed to coating a glass bulb with a phosphorescence phosphor, is that during normal operation, light emitted by the sealed glass tube 110 illuminates a space uninhibited. In other words, the light emitted by the light bulb 100 will illuminate a space without having to travel through a phosphor coating applied to a glass bulb.

FIG. 2 depicts an exploded assembly of a compact fluorescent light bulb 200 consistent with an exemplary embodiment of the present invention. Assembly of a compact fluorescent light bulb 200 consistent with an exemplary embodiment of the present invention comprises inserting a reflector 240 into an energy storage element 230. The reflector 240/energy storage element 230 assembly is inserted into a sealed glass tube 210. The sealed glass tube 210 is connected to a ballast 220 using standard techniques known in the art.

The energy storage element 230 may be constructed in a variety of fashions. In various embodiments, the energy storage element 230 may be a translucent polymer, ceramic or other light conducting material combined with a luminescent phosphor. The combination may comprise a mixture of luminescent phosphor dispersed throughout the polymer or a luminescent phosphor applied to a polymer as a surface coating. The polymer, ceramic or other light conducting material is not limited to a thermoset or thermoplastic resin. A non-exclusive list of examples of a translucent polymer or other light conducting material includes polyvinyl chloride (PVC), polyethylene, ethyl acetate, polystyrene, polypropylene, and glass.

In an exemplary embodiment, the energy storage element 230 comprises a light conducting polymer combined with a phosphorescence phosphor. Furthermore, in an exemplary embodiment the phosphorescence phosphor comprises either SrMgAl₄O₈:Eu²⁺Dy³⁺ or Sr₂MgAl₁₀O₁₈:Eu²⁺Dy³⁺. In alternate embodiments, the energy storage element 230 is comprised of at least 52% by volume of a substrate and at most 48% by volume of a luminescent phosphor. In an exemplary embodiment, the energy storage element 230 is composed of about 80% by volume of a substrate and about 20% by volume of a phosphorescence phosphor distributed throughout the substrate.

Electromagnetic radiation incident on the energy storage element 230 during normal usage of the light bulb, or from natural sources such as the sun, charges the energy storage element 230. Upon removal of the energy storage element 230 from a source of incident electromagnetic radiation, the energy storage element 230 will exhibit phosphorescence. The length of time the energy storage element 230 exhibits phosphorescence depends on factors such as the wavelength of incident radiation, the amount of exposure time to incident radiation, and the particular phosphor in use.

The reflector 240 may be constructed in a variety of fashions and from a variety of materials. In an exemplary embodiment, the reflector 240 comprises materials such as a transparent, semitransparent, or translucent polymer, metals, alloys, or ceramics. While the reflector 240 is not required, during normal operation of the light bulb or emission of light by the energy storage element 230 the reflector 240 reflects light that is directed toward the center of the light bulb 100 out into the space being illuminated. In addition, the reflector 240 may be any color; however, in an exemplary embodiment the reflector 240 is white and opaque.

FIG. 3 depicts a compact fluorescent light bulb 300 consistent with an alternate embodiment of the present invention. The compact fluorescent light bulb 300 comprises a sealed glass tube 310, ballast 320, energy storage element 330, glass bulb 350, and reflector (not shown). As depicted in FIG. 3, the sealed glass tube 310 is helical in shape and encircles the energy storage element 330. By encircling the energy storage element 330, light emitted by the sealed glass tube 310 charges the energy storage element 330 during operation of the light bulb 300.

The glass bulb 350 may be used to give the compact fluorescent light bulb 300 the look of a traditional incandescent light bulb. The glass bulb 350 may be formed into various shapes to give the light bulb different appearances. In addition, the glass bulb 350 may contain coatings or pigmentations to alter the color of light emitted by both the light bulb and the energy storage element 330. Furthermore, the glass bulb 350 may be used on other embodiments such as that depicted in FIG. 1 without departing from scope of the invention.

FIG. 4 depicts an exploded assembly of a compact fluorescent light bulb 400 consistent with an alternate embodiment of the present invention. Assembly of a compact fluorescent light bulb 400 consistent with an alternate embodiment of the present invention comprises inserting a reflector 440 into an energy storage element 430. The reflector 440/energy storage element 430 assembly would then be encircled by a sealed glass tube 410. The sealed glass tube 410 would then be connected to a ballast 420 using standard techniques known in the art. After assembly of the overall compact fluorescent light bulb 400 a glass bulb 450 may then be added to give the compact fluorescent light bulb 400 the look of a traditional incandescent light bulb.

As depicted in FIG. 4, the energy storage element 430 is molded to match the helical form of the sealed glass tube 410. As shown in FIG. 1 and FIG. 2, there is no requirement that the energy storage element 430 be molded to the contours of the sealed glass tube 410. Furthermore, while it is not shown, the reflector 240 may be molded to match the contours of the energy storage element 230 without departing from the scope of the invention.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

I claim:

1. A light bulb comprising:
a light emitting element; and
an energy storage element;
wherein said energy storage element comprises a luminescent phosphor material,
and wherein said energy storage element is encircled by said light emitting element.

2. The light bulb of claim 1 further comprising a reflector.

3. The light bulb of claim 2, wherein said reflector is inserted into said energy storage element.

4. The light bulb of claim 2, wherein said reflector is proximate said energy storage element.

5. The light bulb of claim 1, wherein said luminescent phosphor material is a photoluminescent phosphor.

6. The light bulb of claim 1, wherein said luminescent phosphor material is a phosphorescence phosphor.

7. The light bulb of claim 1, wherein said luminescent phosphor material comprises SrMgAl₄O₈:Eu²⁺Dy³⁺.

8. The light bulb of claim 1, wherein said luminescent phosphor material comprises Sr₂MgAl₁₀O₁₈:Eu²⁺Dy³⁺.

9. A light bulb comprising:
an energy storage element
a light emitting element positioned proximate said energy storage element; and
a reflector;
wherein said energy storage element comprises a luminescent phosphor material,
and wherein said reflector is positioned proximate said energy storage element.

10. The light bulb of claim 9, wherein said luminescent phosphor material is a photoluminescent phosphor.

11. The light bulb of claim 9, wherein said light bulb is a fluorescent light bulb.

12. The light bulb of claim 9, wherein said light bulb is a self-ballasted compact fluorescent light bulb.

13. The light bulb of claim 9, wherein said light bulb is an incandescent light bulb.

14. An energy storage element comprising a substrate and a luminescent phosphor wherein said luminescent phosphor is dispersed throughout said substrate.

15. The energy storage element of claim 14, wherein said substrate material is a polymer.

16. The energy storage element of claim 15, wherein said substrate is polyvinyl chloride (PVC).

17. The energy storage element of claim 15, wherein said substrate is polyethylene.

18. The energy storage element of claim 14 comprising at least 52% by volume said substrate and at most 48% by volume said luminescent phosphor.

19. The energy storage element of claim 18 containing 80% by volume said substrate and 20% by volume said luminescent phosphor.

20. The energy storage element of claim 14, wherein the energy storage element is manufactured by injection molding.

21. The energy storage element of claim 14, wherein the energy storage element is manufactured by extrusion.
